(19) United States
(12) Patent Application Publication
(10) Pub. No.: US 2026/0300240 A1
(43) Pub. Date: Oct. 1, 2026

(54) ENTITY RESOLUTION AND MATCHING FRAMEWORK

(71) Applicant: The Johns Hopkins University, Baltimore, MD (US)

(72) Inventors: Tayler A. Streich, Hanover, MD (US); Vijay Narayan, Silver Spring, MD (US); Ava L. Scharfstein, Park City, UT (US); Sarah K. Kocsis, Sykesville, MD (US); Mark J. Panaggio, Odenton, MD (US)

(21) Appl. No.: 19/311,859

(22) Filed: Aug. 27, 2025

Related U.S. Application Data
(60) Provisional application No. 63/781,748, filed on Apr. 1, 2025.

(51) Int. Cl. G06F 16/215

(52) U.S. Cl. CPC G06F 16/215

(57) ABSTRACT

Provided herein are system, apparatus, device, method and/or computer program product aspects, and/or combinations and sub-combinations thereof for entity resolution and entity matching. A plurality of entity names in a target dataset are preprocessed by a language processing system to correct errors. Then, numerical embeddings of the plurality of entity names are generated using a text embedding model. A set of clusters that each include at least one numerical embedding of an entity name are generated. To identify duplicate entity names, a candidate cluster merge is generated between the two clusters in the set of clusters that have the highest similarity or lowest distance scores. Then an external auditing system accepts or rejects the candidate cluster merge. In response to the auditing system accepting the candidate cluster merge, the candidate clusters are merged.

### CROSS-REFERENCE TO RELATED APPLICATIONS

This application claims the benefit under 35 U.S.C. § 119(e) of U.S. Provisional Application No. 63/781,748, filed on Apr. 1, 2025, which is incorporated by reference herein in its entirety.

### STATEMENT REGARDING FEDERALLY-SPONSORED RESEARCH AND DEVELOPMENT

This invention was made with Government support under Contract No. 75A50122C00052 awarded by the United States Department of Health and Human Services. The Government has certain rights in the invention.

### BACKGROUND

Text data, particularly when collected from multiple sources, is often subject to inconsistencies due to variability in spelling, word choice, punctuation, and the use of abbreviations. A lack of standard nomenclature may create significant challenges when processing and aggregating data. For instance, in a dataset containing country names, the United States might appear as “United States of America”, “United States”, or “US” in different records. Without resolving these discrepancies, analytical tools might treat them as distinct entities, leading to redundancy or fragmented insights. Entity resolution, a critical step in addressing this data quality concern, involves identifying and linking data points that refer to the same real-world entity, but may be represented differently across the data in order to ensure that clean and standardized data is available for analysis.

### SUMMARY

Provided herein are system, apparatus, device, method and/or computer program product aspects, and/or combinations and sub-combinations thereof for entity resolution and entity matching in a dataset.

In some aspects, a plurality of entity names in a target dataset are preprocessed by prompting a language processing system to provide edits to the plurality of entity names. Then, numerical embeddings of the plurality of entity names are generated using a text embedding model and set of clusters that each include at least one numerical embedding of an entity name are generated. To identify duplicate entity names, a candidate cluster merge is generated between the two clusters in the set of clusters that have the highest similarity or lowest distance scores. Then an external auditing system accepts or rejects the candidate cluster merge. If the auditing system accepts the candidate cluster merge, the first cluster and the second cluster are merged into new cluster and the similarity or distance values between clusters are updated to reflect the new cluster. If the auditing system rejects the candidate cluster merge, the first and second cluster are not merged and the similarity or distance values are updated to reflect the rejected candidate merge. This process may be repeated until a predefined number of candidate cluster merges have been rejected.

In some aspects, entity names in a target dataset are matched to entity names in a reference dataset. Numerical embeddings of the entity names in the target dataset and reference dataset are generated. Then a candidate match is generated between the entity name in the target dataset and the entity name in the reference dataset that have the highest similarity or smallest distance value. The candidate match is sent to an auditing system for review. If the auditing system accepts the candidate match, the entity name in the target dataset is standardized to match the entity name in the reference dataset. If the auditing system rejects the candidate match, another candidate match is generated between the same entity name from the target dataset and another entity name in the reference dataset. This may be repeated until a match is found or a subsequent number of candidate matches are rejected and the entity name is declared a unique entity. This process may repeat until every entity name in the target dataset has been considered.

### BRIEF DESCRIPTION OF THE DRAWINGS

The accompanying drawings are incorporated herein and form a part of the specification.

FIG. 1 shows an example data processing platform architecture, according to some aspects.

FIG. 2 shows a flowchart of an example method for processing a dataset, according to some aspects.

FIG. 3 shows a flowchart of an example method for performing entity resolution, according to some aspects.

FIG. 4 shows a flowchart of an example method for performing entity matching, according to some aspects.

FIG. 5 shows an example computer system, according to some aspects.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product aspects, and/or combinations and sub-combinations thereof for entity resolution and entity matching.

Approaches for entity resolution and entity matching include a variety of rule-based and machine leaning based approaches. In rule-based approaches, one may define a series of deterministic transformations that can be implemented programmatically in order to standardize identifiers. These transformations can be used to apply consistent capitalization, remove white-space and/or punctuation, or to replace common abbreviations or misspellings. Then, additional rules may be added to determine whether similar but not identical strings refer to the same entity and should be considered a match. A potential drawback of this approach is that it can be difficult to anticipate all of the possible variations that will be encountered a priori. As a result, choosing the appropriate set of rules required to remove all inconsistencies and find all matches still requires significant manual effort. Furthermore, due to their rigidity, these rules typically require continual updates to ensure that they generalize as new data is added.

In another approach, entity resolution and entity matching are split into four main steps: blocking, block processing, entity matching, and entity clustering. For large datasets, the blocking and block processing steps are used to break the problem into smaller sub problems in order to reduce the computational burden. Then the third step, entity matching, involves selecting pairs of records, either within a single dataset or across datasets, and using a machine learning model to determine if they refer to the same entity. The specifics of how these determinations are made may vary based on the features available, the size of the dataset, etc. The final step, entity clustering, involves using all matched pairs to identify clusters of records that refer to the same entity and merging these clusters. More information on this approach may be found in Christophides, Vassilis, et al. “An overview of end-to-end entity resolution for big data.” ACM Computing Surveys (CSUR) 53.6 (2020): 1-42. While this approach may be effective, the entity matching step often requires significant fine tuning or a large number of labeled examples to achieve good performance and does not include a method for determining an appropriate name for each cluster of records. Additionally, this approach is computationally expensive when the number of pairs of records considered is large.

In another approach, a large language model (LLM) is leveraged to extract an entity name using a carefully crafted prompt. At the cost of one query per record, one can standardize entity identifiers even within unstructured data. This avoids the costly step of considering pairs of records, which is critical because LLM queries tend to be computationally demanding. However, because each record is considered independently, the standardized names are not necessarily consistent even when they refer to the same entity. That is, records corresponding to the same entity may be given different identifiers and therefore will fail to be matched. For example, in one record the extracted entity might be “BOB’S PHARMA INC” and in another it might be “BOB’S PHARMACY”.

The aspects described herein provide a generalizable and customizable entity resolution framework for resolving data quality issues in datasets with natural language entity identifiers. The entity resolution framework may provide both entity resolution and entity matching, which, when used in combination, entity resolution and entity matching help users maintain and update their knowledge-base of entities with minimal effort.

In some aspects, entity resolution seeks to achieve internal consistency within a dataset by identifying groups of rows that refer to the same entity. Entity resolution begins with a dataset of raw entity names (e.g., names of companies, geographic locations, etc.), plus any additional relevant features (e.g., street address, GPS coordinates). In the aspects described herein, similarity or distance values between numerical embeddings of the raw entity names are calculated and compared to generate candidate cluster merges between pairs or groups of the entity names. The candidate cluster merge is then accepted or rejected by an external auditing system that is capable of analyzing the semantic meaning of the entity names. This process is repeated until a predefined number of candidate cluster merges have been rejected by the external auditing system.

In some aspects, entity matching seeks to achieve consistency between a target dataset and a reference dataset by matching rows that refer to the same entity. This may be accomplished by matching entity names (or features) in the target dataset with entity names (or features) in a reference dataset that has already been standardized. For example, candidate matches between the target dataset and the reference dataset may be generated and sent to an auditing system for review. The auditing system may then accept or reject the candidate match. This process is repeated for all entity names in the target dataset.

In some aspects, an entity resolution framework described herein may provide several advantages over other entity resolution and entity matching methods. For example, the use of text embedding models and language models makes it possible to account for semantics in ways that are not captured by traditional methods without an extensive training set. Furthermore, due to computational constraints, most LLM-based approaches consider each record in a vacuum and thus fail to account for the broader context of a dataset, while the disclosed entity resolution framework is able to compare groups of records by using hierarchical clustering to generate a prioritized set of candidate merges between groups of records. This makes it possible to use LLM-based approaches to compare similar entities in a scalable way without needing to examine each pair of records. As a result, the entity resolution framework described herein catches more duplicates than most LLM-based approaches without a need to provide large numbers of labeled examples. Furthermore, the entity resolution framework provided herein allows for the use of both human and LLM auditing systems to evaluate potential merges. This novel approach allows users to improve performance by refining a natural language prompt rather than having to adjust the embedding, clustering, or matching models directly. This makes it easier to customize a model to ensure that the desired facets of similarity are accounted for without manually labeling large amounts of data. Additionally, because the prompts can be specified using natural language and the models used can capture semantic relationships, this approach may be easier to implement and significantly more flexible than rules-based approaches.

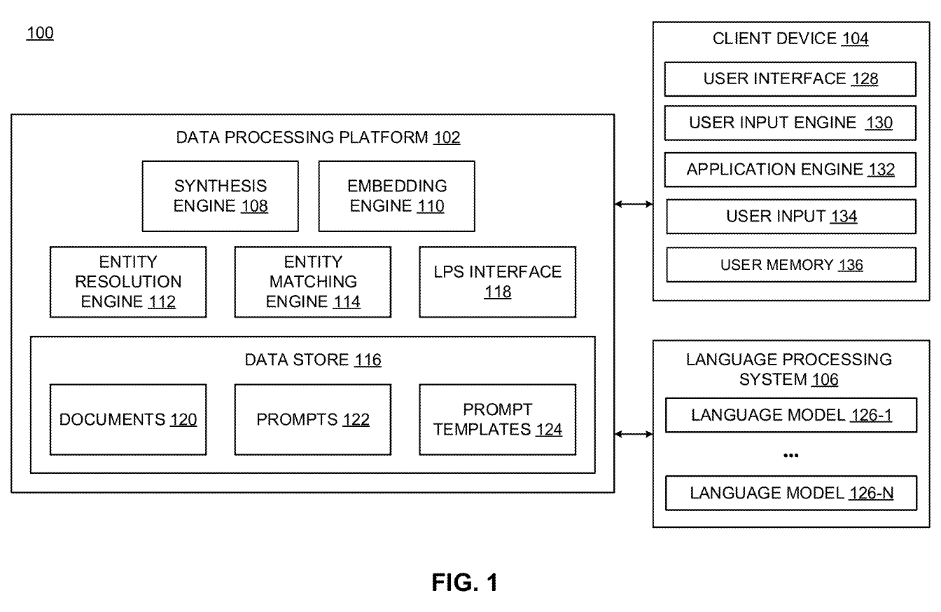

FIG. 1 shows an example block diagram of a data processing platform architecture 100, according to some aspects. Operations described may be implemented by processing logic that may comprise hardware (e.g. circuitry, dedicated logic, programmable logic, microcode, etc.), software (e.g. instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Example data processing platform architecture 100 may include a data processing platform 102, a client device 104, and a language processing system (LPS) 106. In some aspects, example data processing platform architecture 100 may be implemented partially or entirely at client device 104. Alternatively or additionally, in some aspects, example data processing platform architecture 100 may be implemented partially or entirely at third party servers or within the cloud. In such aspects, client device 104, data processing platform 102, and LPS 106 may be communicatively coupled with each other via one or more networks, such as one or more wired or wireless local area networks (“LANs,” including Wi-Fi, mesh networks, Bluetooth, near-field communication, etc.) or wide area networks (“WANs”, including the Internet).

In some aspects, data processing platform 102 may include a synthesis engine 108, an embedding engine 110, an entity resolution engine 112, an entity matching engine 114, a data store 116, and a LPS interface 118. In some aspects, data processing platform 102 may be implemented as one or more servers and/or one or more cloud servers. Data processing platform 102 may also be implemented as a variety of centralized or decentralized computing devices. For example, data processing platform 102 may operate on a mobile device, a laptop computer, a desktop computer, grid-computing resources, a virtualized computing resource, cloud computing resources, peer-to-peer distributed computing devices, a server farm, or a combination thereof. Data processing platform 102 may be centralized in a single device, distributed across multiple devices within a cloud network, distributed across different geographic locations, or embedded within a network.

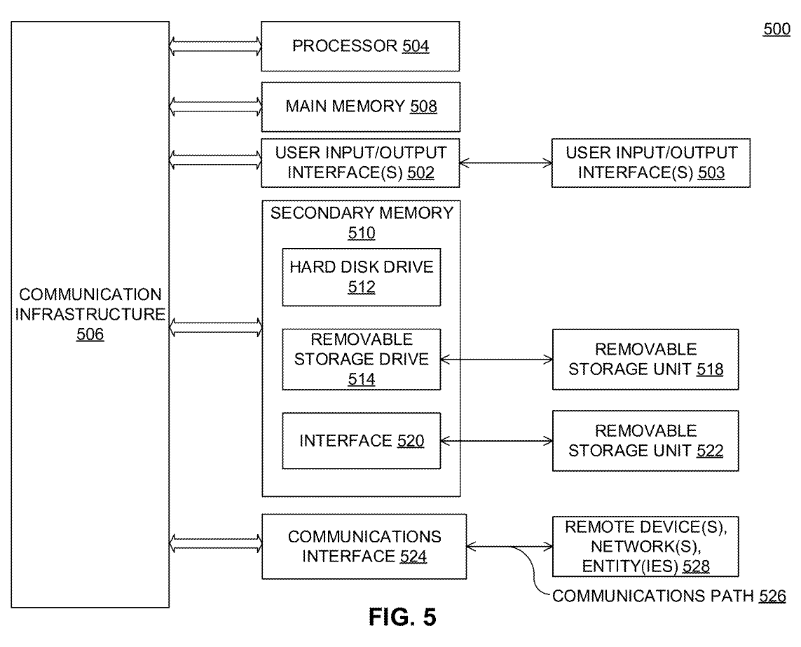

In some aspects, data store 116 may store various data used by data processing platform 102, including documents 120, prompts 122, and prompt templates 124. Documents 120 may include dataset(s) containing natural language entities. Data store 116 may be stored, for example, in a volatile memory (e.g. random access memory (RAM)), a non-volatile storage device (e.g. a disk), or in a distributed and/or redundant manner across multiple memories and/or storage devices. In some aspects, data store 116 is managed by and accessed via a corresponding database management system (DBMS), which is not shown in FIG. 1 for the sake of simplicity. Data store 116 and the corresponding DBMS may be implemented on one or more computer systems, such as computer system 500 as described below in reference to FIG. 5. Data store 116 and the corresponding DBMS may also be implemented on one or more servers of an enterprise network and/or a cloud computing network.

LPS 106 may be a distributed computing system configured to execute one or more natural language machine learning models, language models 126-1 to 126-N (collectively, “language models 126”). In some aspects, language models 126 may be transformer and/or neural network-based language models trained on large amounts of textual data (e.g. LLMs). Language models 126 may employ various model architectures including, but not limited to, encoder-decoder, causal decoder, and prefix decoder architectures. Various components of data processing platform 102 may leverage LPS interface 118 to communicate with LPS 106 and language models 126 to perform various tasks, such as pre-processing datasets, auditing entity resolution and matching tasks, and more.

Generally, prompts 122 may refer to unimodal or multimodal natural language instructions or computer code that is fed into a language processing system (e.g. LPS 106). Prompts 122 may include contexts, user instructions, system instructions, and/or other metadata for guiding LPS 106 towards generating a desired output. Prompts 122 may come in many different forms and have various different applications. For example, prompts 122 may define functionality for pre-processing a document, auditing entity resolution, and auditing entity matching.

Prompt templates 124 may define certain structures for prompts 122 to follow before prompts 122 are submitted to LPS 106. Prompt templates 124 may leverage predefined configurations or optimizations for obtaining more accurate and higher quality responses from LPS 106. For example, prompt templates 124 may provide additional context for a task and specific rules or guidelines to follow during inference.

Synthesis engine 108 may perform various functions within data processing platform 102. In some aspects, synthesis engine 108 may wrap a natural language entity name or pair of natural language entity names inside a prompt template (e.g., prompt templates 124). Synthesis engine 108 may then employ LPS interface 118 to query LPS 106 using the constructed prompt to preprocess the natural language entity name or to determine if a pair of natural language entity names should be clustered or matched. Alternatively, synthesis engine 108 may employ LPS interface 118 to query LPS 106 using a predefined prompt (e.g., prompts 122 or a prompt submitted by a user of client device 104).

In some aspects, synthesis engine 108 may choose an auditing system for reviewing candidate matches in entity resolution and entity matching tasks. For example, synthesis engine 108 may choose an auditing system based on a similarity score received from entity resolution engine 112 or entity matching engine 114. If a score falls within a predefined threshold, synthesis engine 108 may choose a user of client device 104 as the auditing system. Conversely, if the score falls outside of a predefined threshold, synthesis engine 108 may choose LPS 106 as the auditing system.

In some aspects, synthesis engine 108 is configured to populate a dataset with standardized entity names. For example, synthesis engine 108 may create another column in the dataset that standardizes entity names “Bob’s pharmacy,” “Robert’s Pharmacy,” and “Bob’s Pharmacy Inc.” to “Bob’s Pharmacy.”

Embedding engine 110 may convert natural language entity names within documents 120 into numerical representations (e.g., vectors, matrices, etc.). This makes it possible to compute distances and/or similarities between the entity names. Embedding engine 110 may leverage one or more embedding techniques to generate the numerical representations. For example, embedding engine 110 may leverage LLM-based text embedding models, classical machine learning based text embedding models (e.g., term frequency-inverse document frequency), and the like. In some aspects, LLM-based text embedding models may be advantageous in natural language-based applications due to their ability to account for semantic similarity between superficially different strings. For example, an LLM-based text embedding model may generate similar vector embeddings for “Zaire” and “Democratic Republic of the Congo” because they refer to the same country.

Entity resolution engine 112 may be configured to identify and link different representations of the same entity in a target dataset. In some aspects, entity resolution engine 112 may initially treat each entity name in the target dataset as a cluster. Then, entity resolution engine 112 may generate candidate cluster merges between the clusters using various techniques, such as hierarchical clustering (e.g. agglomerative clustering, divisive clustering, etc.), density-based clustering (e.g. DBSCAN, OPTICS, etc.), partitioning clustering (e.g. k-means clustering, k-medoids clustering, etc.), or model-based clustering (e.g. Gaussian mixture models, Dirichlet process mixtures, etc.). After generating a candidate cluster merge between two clusters, entity resolution engine 112 may send the candidate cluster merge to an auditing system, such as LPS 106 or client device 104. Entity resolution engine 112 may then receive instructions on whether to accept or reject the merge from the auditing system. If the candidate cluster merge is accepted, entity resolution engine 112 may merge the respective clusters. Entity resolution engine 112 may iteratively generate candidate cluster merges until a predefined number of the candidate cluster merges have been rejected by the auditing system or until a user of client device 104 manually stops the clustering process.

In some aspects, entity resolution engine 112 may score the candidate cluster merges using similarity or distance metrics, such as cosine similarity, Euclidean distance, and the like. The score may be leveraged by other components of data processing platform 102, such as synthesis engine 108, to choose which auditing system should evaluate each candidate cluster merge.

Entity matching engine 114 may be configured to match entity names in a target data set with entity names in a reference dataset. Entity matching engine 114 may leverage common matching techniques, such as deterministic matching techniques, trained machine learning models, graph-based matching techniques, greedy algorithms (e.g., sequential greedy matching algorithms), and the like. In some aspects, entity matching engine 114 incorporates an auditing system into an entity matching process. For example, after generating a candidate match between an entity name in the target dataset and an entity name in the reference dataset, entity matching engine 114 may send the candidate match to an auditing system, such as LPS 106 or client device 104. Entity matching engine 114 may then receive instructions on whether to accept or reject the match from the auditing system. If the candidate match is rejected, entity matching engine 114 may try to find another match for the entity name from the target dataset by, for example, repeatedly generating new candidate matches between the entity name from the target dataset and entity name from the reference dataset until a match is approved or until a predefined number of matches have been rejected. If the auditing system approves a candidate match, entity matching engine 114 may match the entity names. This process may repeat until all entity names in the target dataset have been considered.

In some aspects, entity matching engine 114 may score the candidate match using similarity or distance metrics, such as cosine similarity, Euclidean distance, or the like. The score may be leveraged by other components of data processing platform 102, such as synthesis engine 108, to choose which auditing system should evaluate each candidate match.

Client device 104 may be one or more of a desktop computer, a laptop computer, a tablet, a mobile phone, a smart appliance such as a smart television, and/or a wearable apparatus of the user that includes a computing device (e.g. a smartwatch, smart glasses, or a virtual or augmented reality computing device). Additional and/or alternative client devices may be contemplated. Client device 104 may include a corresponding user interface 128, user input engine 130, application engine 132, user input 134, and user memory 136.

User interface 128 may be configured to render content for audible or visual presentation to a user of client device 104 using one or more user interface output devices. For example, client device 104 may include a display or projector that enables content to be provided for visual presentation to a user via client device 104. Alternatively or additionally, client device 104 may include one or more speakers that enable content to be provided for audible presentation to a user via client device 104. In some aspects, a user may interact with a software application via user interface 128. For example, a user may utilize user interface 128 to generate a configuration file for an entity resolution or entity matching process, accept or reject a candidate cluster merge or candidate match, generate prompts or prompt templates, upload or edit a dataset, etc. To facilitate user interaction, user interface 128 may include text boxes, drop down menus, and the like.

Application engine 132 may execute one or more software applications on client device 104. In some aspects, application engine 132 may submit a dataset, configuration file, or other user input to data processing platform 102. Application engine 132 may then receive unimodal, multimodal, or other responses to and from data processing platform 102 in response to entity resolution and/or matching, which may then be rendered onto user interface 128 (e.g., audibly or visually). Application engine 132 may execute one or more software applications that are separate from an operating system of the client device 104 or may alternatively be implemented directly by the operating system of client device 104. For example, the application engine 132 may execute one or more software applications via a web browser or assistant.

User input 134 may represent an input provided by a user of client device 104 and may be detected via user input engine 130. For example, user input 134 may include datasets for entity resolution and matching, text input that is used to generate a configuration file, actions that indicate acceptance/rejection of a candidate merge or candidate match, etc. In some aspects, user input 134 comprises text that is typed via a physical or virtual keyboard, a user selection that is made via a touch screen or a mouse of client device 104, a spoken voice query that is detected via a microphone of client device 104 (or directed to a voice assistant running at client device 104), or an image or video query that is based on vision data captured by a vision component of client device 104.

User memory 136 may include a data store containing data about a user of client device 104 or about client device 104 itself. In some aspects, user memory 136 may store one or more inputs (e.g. user input 134) made by a user of client device 104. User memory 136 may also store a context of client device 104. As just one example, user memory 136 may store data input by a user with data processing platform 102. User memory 136 may also store user interaction data about current or recent interactions between a user or multiple users and client device 104. In some aspects, user memory 136 may also store location data about current or recent locations of client device 104 or a geographical region associated with a user of client device 104. User memory 136 may also store user attribute data, user preference data, a user profile, or various configurations relating to client device 104 or a user of client device 104.

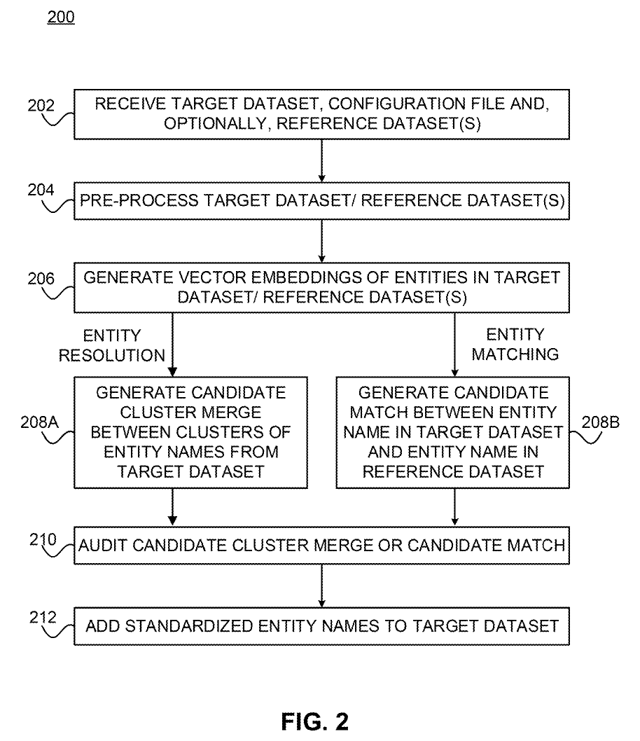

FIG. 2 shows a flowchart of an example process 200, according to some aspects. Process 200 may, for example, describe a process for resolving and/or matching natural language entities in a dataset. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 2, as will be understood by a person of ordinary skill in the art. Process 200 shall be described with reference to FIG. 1. However, process 200 is not limited to those example aspects.

At step 202, data processing platform 102 receives a target dataset. The target dataset may include a plurality of natural language entity names. In some aspects, entity names in the target dataset are thematically cohesive (e.g., belonging to a common domain, theme, context, etc.) such that clear criteria for comparison and matching between the entity names may be defined. The plurality of entity names in the target dataset may be non-standardized, such that entity names that refer to the same entity have different spellings, abbreviations, etc.

In some aspects, data processing platform 102 may also receive features related to the target dataset that help the data processing platform further distinguish and identify common entities. For example, if the entity names in the target dataset are company names, the data processing platform may receive a list of potential company names that may be found in the target dataset and zip codes for each company headquarters.

In some aspects, data processing platform 102 may also receive a configuration file at step 202. The configuration file may include information on which columns of the dataset include relevant identifiers and features, specify prompts for language processing system 106, specify model(s) for generating vector embeddings, specify a linkage criterion for clustering, specify stopping criteria for entity resolution and entity matching processes, etc.

In some aspects, data processing platform 102 also receives a reference dataset(s) at step 202. The reference dataset(s) may include standardized natural language entity names that serve as ground truth data during entity matching tasks. The reference dataset(s) may have a single row per entity.

In some aspects, data processing platform 102 receives the target dataset, features, configuration file, and/or reference dataset(s) from a user via client device 104. For example, the user may upload the datasets and/or specify components of the configuration file via user interface 128. Then, application engine 132 may send the dataset(s)/configuration file to data processing platform 102. Additionally or alternatively, data processing platform 102 may retrieve the target dataset and/or reference dataset(s) from data store 116 in response to instructions provided by the user via client device 104.

At step 202, data processing platform 102 may also choose between an entity resolution and entity matching task. Data processing platform 102 may choose the task based on instructions included in the configuration or otherwise specified by a user of client device 104. Alternatively, data processing platform 102 may automatically choose a task based on the type data received at step 202. For example, if data processing platform 102 receives a reference dataset, it may automatically choose an entity matching task.

At step 204, data processing platform 102 may pre-processes the target dataset. In some aspects, data processing platform 102 may leverage LPS interface 118 to send a prompt to LPS 106. The prompt may instruct LPS 106 to perform an initial cleaning of raw entity names. The initial cleaning may include fixing grammatical errors (e.g., removing punctuation, expanding abbreviations, capitalizing names, correcting spelling errors), identifying a source language in the entity names, and the like. The prompt may also provide examples of correct and incorrect responses and context for entity names. For example, if the target dataset relates to manufacturers of medical supplies, the prompt may include: “You will be provided with a string containing the raw name of manufacturers of medical supplies and possibly additional information about that manufacturer such as the state, zip, street address, and geopoint of residence, or earliest or latest date of a transaction. These names may be official or unofficial. Think carefully about your answer and then respond with the official short-form name of the medical manufacturer company.”

In some aspects, data processing platform 102 receives the prompt from the configuration file provided by the user at step 202. Alternatively, data processing platform 102 may retrieve the prompt from data store 116.

In some aspects, each natural language data entry in the target dataset may be preprocessed independently. For example, data processing platform 102 may send multiple prompts to LPS 106 sequentially or in parallel, wherein each prompt only includes one natural language entity name from the target dataset.

At step 206, data processing platform 102 may leverage embedding engine 110 to generate numerical representations (e.g., vectors, matrices, etc.) of the natural language entities in the dataset. To generate the vector representations, embedding engine 110 may leverage text embedding models (e.g., large language based embedding models, classical machine-learning based embedding models, etc.) The text embedding model leveraged by embedding engine 110 may be specified in the configuration file received by data processing platform 102 at step 202.

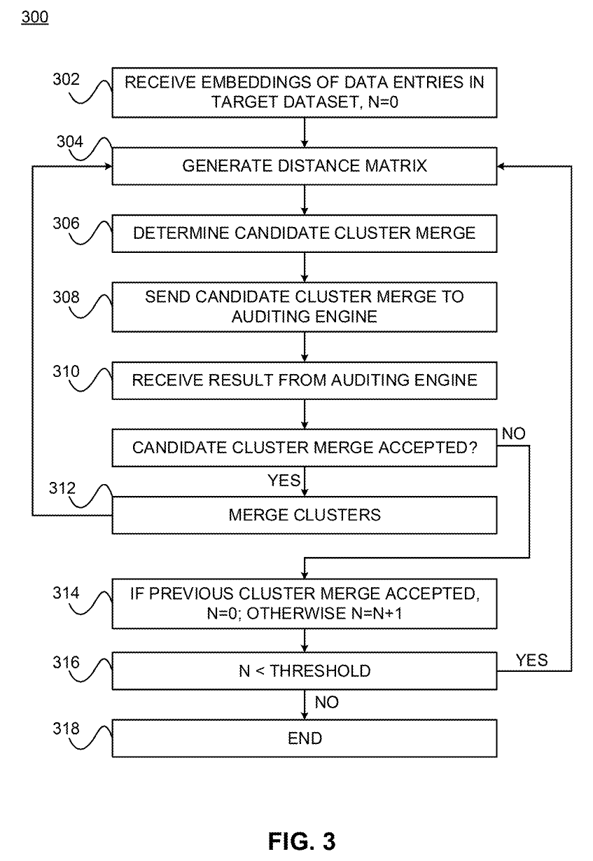

If data processing platform 102 chooses an entity resolution task, data processing platform 102 may leverage entity resolution engine 112 to generate a candidate cluster merge between clusters of natural language entity names from the target dataset at step 208A. For example, entity resolution engine 112 may generate similarity or distance values between each pair of clusters formed from entity names the target dataset and choose the pair of clusters with the highest similarity value or lowest distance value as a candidate cluster merge. More details on generating candidate cluster merges are given below in reference to FIG. 3.

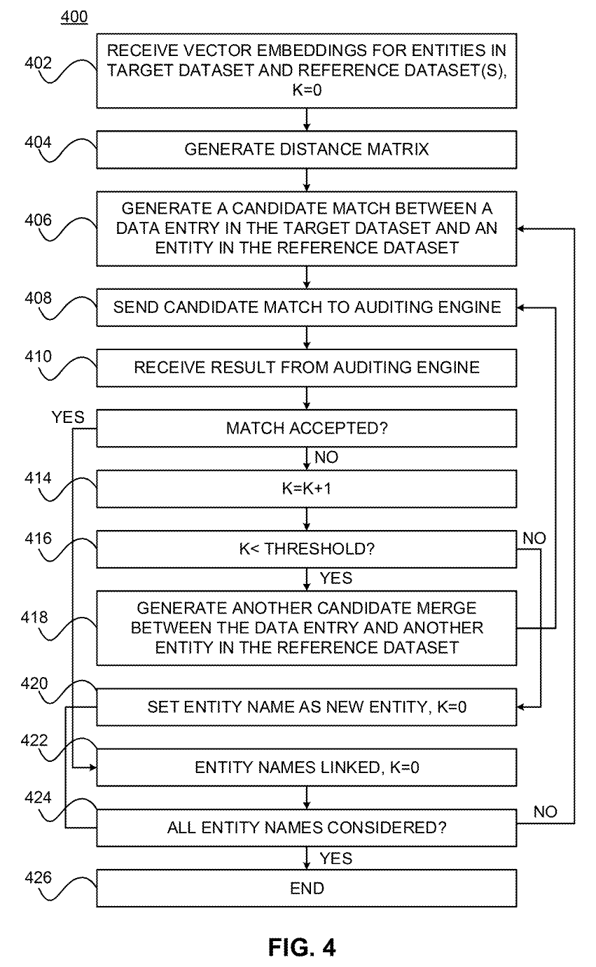

If data processing platform 102 chooses an entity matching task, data processing platform 102 may leverage entity matching engine 114 to generate a candidate match between an entity name in the target dataset and an entity name in the reference dataset(s) at step 208B. The candidate match may include the entity name in the target dataset and the standardized entity name in the reference dataset(s) with which the entity name in the target dataset has the highest similarity value or lowest distance value. More details on generating candidate matches are given below in reference to FIG. 4.

At step 210, data processing platform 102 may send the candidate cluster merge or candidate match generated at step 208A or 208B to an auditing system. In some aspects, the auditing system includes LPS 106. In this scenario, data processing platform 102 may leverage synthesis engine 108 to generate a prompt for the language processing system. The prompt may provide instructions and criteria for determining if two entities match, one or more examples of entities that match, and/or one or more examples of entities that do not match. The instructions/criteria may be specific to the type of data in the target dataset and/or reference dataset(s). For example, a prompt may read:

“You are an entity resolution tool within a data pipeline. You will be provided with a pair of names of manufacturers of medical products. You need to determine if these two names refer to the same manufacturer (i.e. if they match). Please respond with either ‘True’ (if the names refer to the same manufacturer) or ‘False’ (if they refer to different manufacturers). If it is unclear whether a pair of names matches, please respond with "False". However, different branches of the same company (i.e. different locations) should be considered as matches. Keep in mind that common words like “incorporated”, “company”, “medical”, “supply”, “healthcare”, “pharmaceutical” and “scientific” will often appear in names for different manufacturers, and therefore may not be useful for determining if names match. Proper names should be the same (or at least abbreviated versions of the same word) for raw names to be considered a match. Note also that locations at the beginning a string are usually part of the manufacturer name. However, locations at the end of a string may indicate a particular branch for the manufacturer. REMEMBER, if the pair of entities does not match, then the correct response is “False”. Please take your time and respond with True only when you are confident that the entities match. Otherwise respond with False. Do not provide other text.”

In some aspects, the auditing system is a user of client device 104. Data processing platform 102 may send the candidate cluster merge or candidate match to client device 104 via application engine 132. Application engine 132 may display the candidate cluster merge or candidate match to the user via user interface 128. After the user accepts or rejects the candidate cluster merge/candidate match, application engine 132 may send the decision back to data processing platform 102.

In some aspects, data processing platform 102 may choose which auditing system should evaluate the candidate cluster merge or candidate match based on a score generated by entity resolution engine 112 or entity matching engine 114. For example, entity resolution engine 112/entity matching engine 114 may generate a similarity score between the clusters/entity names from the candidate cluster merge or candidate match. If the similarity score falls within a predefined range, data processing platform 102 may send the candidate cluster merge or candidate match to a user (e.g., human) for review. If the similarity score falls outside of the predefined range, data processing platform 102 may send the candidate cluster merge or candidate match to LPS 106 for review. In one non-limiting example, a similarity score may take values between 0-1 and the predefined threshold is between 0.25-0.75. The predefined threshold is tunable and may be defined by the user in the configuration file received at step 202.

After data processing platform 102 receives a decision from one of the auditing systems, process 200 may return to the previous step (e.g., 208A or 208B). Steps 208A/208B and 210 may repeat until a stopping criterion is met (for entity resolution/step 208A) or each entity in the target dataset is evaluated (for entity matching/step 208B). More details on entity resolution and entity matching, and their respective stopping criteria, are given below in reference to FIGS. 3 and 4.

At step 212, data processing platform 102 alters the target dataset to include standardized entity names. For example, synthesis engine 108 may add a column to the target dataset that includes the standardized name for each natural language data entry. For entity resolution, synthesis engine 108 may prompt LPS 106 to generate a standardized name for each cluster. For entity matching, the standardized names may match the corresponding entity names from the reference dataset(s).

In some aspects, entity matching is performed after entity resolution. For example, after names in a target dataset are standardized via entity resolution, the standardized names may be matched to names in a reference dataset to ensure that names are standardized across multiple datasets used for an analysis project.

In some aspects, entity resolution is performed after entity matching. For example, entity matching may match multiple rows in a target dataset to rows in a reference dataset. Then, entity resolution may be performed on the unmatched rows to identify any duplicates.

FIG. 3 shows a flowchart of an example process 300, according to some aspects. Process 300 may, for example, describe a process for performing entity resolution using hierarchical clustering on vector embeddings of natural language entity names in a dataset. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art. Process 300 shall be described with reference to FIGS. 1-2. However, process 300 is not limited to these example aspects.

At step 302, entity resolution engine 112 may receive vector embeddings of data entries in a target dataset. As described above, the target dataset may include a plurality of natural-language entity names that are thematically cohesive (e.g., belonging to a common domain, theme, context, etc.) and are non-standardized, such that entity names that refer to the same entity have different spellings, abbreviations, etc.

At step 304, entity resolution engine 112 may generate a distance matrix. The distance matrix may include similarity or distance values between pairs of clusters comprising entity names from the target dataset. Initially, each individual data entry from the target dataset is treated as its own cluster and the distance matrix has dimensions of N by N, where N is the number of entries in the dataset.

During subsequent iterations of process 300, entity resolution engine 112 may update the distance matrix. For example, after a pair of clusters are merged, the distance matrix may be updated to include distance or similarity values between the merged cluster and other clusters related entity names in the target dataset. If a cluster merge is rejected, the distance matrix may be updated, such that non-related entity names are no longer similar.

Entity resolution engine 112 may generate the distance matrix using any technique known in the art. For example, entity resolution engine 112 may leverage techniques such as cosine similarity, Euclidean distance, Jaccard similarity, and the like to calculate similarity or distance values between pairs of clusters that include one entity name. If one cluster in a pair of clusters includes multiple entity names, entity resolution engine 112 may leverage a linkage criterion to calculate the similarity or distance value between the pair of clusters. The linkage criterion may specify a method for computing the distance between clusters based on the distances between their members. Examples of linkage criterion include, but are not limited to, complete linkage clustering, single linkage clustering, unweighted average linkage clustering, weighted average linkage clustering, centroid linkage clustering, median linkage clustering, minimum error sum of squares, etc.

At step 306, entity resolution engine 112 may determine a candidate cluster merge. The candidate cluster merge may include the two clusters with the highest similarity score or lowest distance score, as indicated in the distance matrix calculated at step 304. In some aspects, entity resolution engine 112 scores the candidate cluster merge. For example, entity resolution engine 112 may transform the distances from the distance matrix calculated at 304 such that the largest observed distance corresponds to a score near one and smaller distances correspond to a score near zero or negative one. This may be accomplished using any sigmoidal function, such as a hyperbolic tangent function or the like.

At step 308, entity resolution engine 112 may send the candidate cluster merge to synthesis engine 108 for review. Synthesis engine 108 then sends the candidate cluster merge to an auditing system. The auditing system may include a language processing system (e.g., LPS 106) or a human reviewer (e.g., a user of client device 104). In some aspects, synthesis engine 108 leverages the score generated at step 306 to determine which auditing system should review the candidate cluster merge. For example, if the score falls within a predefined range, synthesis engine 108 may send the proposed cluster merge to a human for review. Alternatively, if the score falls outside of the predefined range, synthesis engine 108 may send the proposed cluster merge to a language processing system for review. In one non-limiting example, cluster merge scores range from 0 to 1 and the predefined range spans 0.25 to 0.75. The predefined range may be specified by the user in the configuration file.

At step 310, entity resolution engine 112 may receive a result from synthesis engine 108. The result may indicate whether the candidate cluster merge is accepted or rejected by the auditing system.

If the candidate cluster merge is accepted, entity resolution engine 112 may merge the clusters in the candidate cluster merge at step 312. Then, process 300 may return to step 304, where the distance matrix is updated to account for the new cluster.

If the candidate cluster merge is rejected, entity resolution engine 112 checks if a stopping criterion has been met. For example, at step 314, entity resolution engine 112 may set a counter variable N that is configured to track the number of consecutive rejections. If the previous candidate cluster merge was accepted, N=0, otherwise N=N + 1. Then at step 316, entity resolution engine 112 may determine if N is less than a threshold value. If N is less than the threshold value, process 300 may return to step 314, where the distance matrix is updated to account for the rejected match (e.g., a similarity or distance value for the non-matching entity names are altered such that they are no longer considered similar).

If N is not less than the threshold value, process 300 may end at step 318. Once process 300 ends, entity names that are grouped within the same cluster may be assigned a standardized name.

FIG. 4 shows a flowchart of an example process 400, according to some aspects. Process 400 may, for example, describe a method for matching natural language entities in a target dataset with entities in a reference dataset. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art. Process 400 shall be described with reference to FIG. 1. However, process 400 is not limited to those example aspects.

At step 402, entity matching engine 114 may receive numerical embeddings of entity names from both a target dataset and a reference dataset(s). The reference dataset(s) may include natural language entity names that have been standardized into a desired format (e.g., for a data processing task). Because they have been standardized, entity names in the reference dataset(s) may serve as a ground truth to which entity names in the target dataset are matched. The target dataset may include a dataset that has not been standardized. For example, entities in the target dataset may refer to the same entities as the reference dataset(s), but have different spellings, grammatical structures, etc.

At step 404, entity matching engine 114 may utilize the numerical embedding of the data entries in the target dataset and reference dataset(s) to generate a distance matrix. The distance matrix may include similarity or distance values between the entities in the target dataset and the entities in the reference dataset(s). The distance matrix may have dimensions N₁ by N₂, where N₁ is the number of rows in the target dataset and N₂ is the number of rows in the reference dataset(s).

At step 406, entity matching engine 114 may generate a candidate match between an entity in the target dataset and an entity in the reference dataset(s). For example, entity matching engine 114 may choose the unmatched data entry in the target dataset that has the smallest distance value or highest similarity value with a data entry in the reference dataset(s). When choosing a candidate match, entity matching engine 114 may only consider data entries of the target dataset that have not been previously considered. If the target dataset has already undergone entity resolution so that there is a single row per entity, a user may add a flag to specify that each row in the reference dataset can be matched to at most one row in the target dataset. In cases where the target dataset has not undergone entity resolution, multiple rows in the target dataset may be matched to the same row in the reference dataset.

In some aspects, entity matching engine 114 may also generate a score that indicates the similarity between the entities in the candidate match. The score may be calculated using common methods, such as cosine similarity or the like. In some aspects, the score is the similarity or distance value calculated at step 404.

At step 408, entity matching engine 114 may send the candidate match to an auditing system for review. The auditing system may include a large language model (e.g., one of language models 126 of LPS 106) or a human (e.g., a user of client device 104). As described above in reference to FIG. 2, entity matching engine 114 may leverage other components of data processing platform 102, such as synthesis engine 108 and LPS interface 118, to send the candidate match to the auditing system.

At step 410, entity matching engine 114 may receive a result from the auditing system. The result may indicate whether the candidate match is accepted or rejected.

If the candidate match is rejected, entity matching engine may try to find another match in the reference dataset(s) for the entity name from the target dataset (i.e., within in the current candidate match). For example, entity matching engine may increase the value of a counter variable K by 1 at step 414. Then, at step 416, the entity matching engine 114 may determine if K is less that a threshold value. If K is less than a threshold value, entity matching engine 114 may generate a new candidate match between the entity name from the target dataset and another entity name in the reference dataset at step 418. Process 400 may then return to step 408, where the new candidate match is sent to the auditor for review.

If K is not less than the threshold value at step 416, entity matching engine 114 may declare the entity name from the target dataset as a new entity (e.g., entity not found in the reference dataset) and reset the value of K to zero at step 420.

If the candidate match is accepted, the entity names in the candidate match are linked at step 422. The value of K may also be reset to zero at step 422 (e.g., when a candidate match is accepted after an initial rejection). After step 420 and 422, entity resolution engine 114 may determine if all entity names in the target dataset have been considered at 424. If not, process 400 may return to step 406, where another candidate match is generated. Otherwise, process 400 ends at step 426.

FIG. 5 shows an example computer system 500, according to some aspects.

One or more computer systems 500 may be used, for example, to implement any of the aspects discussed herein, as well as combinations and sub-combinations thereof. For example, the example computer system may be implemented as part of data processing platform 102, client device 104, LPS 106, etc. Cloud implementations may include one or more of the example computer systems operating locally or distributed across one or more server sites.

Computer system 500 may include one or more processors (also called central processing units, or CPUs), such as a processor 504. Processor 504 may be connected to a communication infrastructure or bus 506.

Computer system 500 may also include customer input/output device(s) 502, such as monitors, keyboards, pointing devices, etc., which may communicate with communication infrastructure 506 through customer input/output interface(s) 502.

One or more of processors 504 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 516. Removable storage unit 516 may include a computer usable or readable storage device having stored thereon computer software (control logic) and/or data. Removable storage unit 516 may be a floppy disk, magnetic tape, compact disk, DVD, optical storage disk, and/ any other computer data storage device. Removable storage drive 514 may read from and/or write to removable storage unit 516.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer or machine useable or readable storage medium having control logic (software) stored thereon may also be referred to herein as a computer program product or program storage device. This includes, but is not limited to, computer system 500, main memory 508, secondary memory 510, and removable storage units 516 and 522, as well as tangible articles of manufacture embodying any combination of the foregoing. Such control logic, when executed by one or more data processing devices (such as computer system 500), may cause such data processing devices to operate as described herein.

Based on the aspects contained in this disclosure, it will be apparent to persons skilled in the relevant art(s) how to make and use aspects of this disclosure using data processing devices, computer systems and/or computer architectures other than that shown in FIG. 5. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for identifying duplicate entity names in a target dataset, comprising:
preprocessing a plurality of entity names in the target dataset by prompting a language processing system to provide edits to the plurality of entity names;
generating numerical embeddings of the entity names in the plurality of entity names using a text embedding model;
generating similarity or distance values between each pair of clusters in a set of clusters, wherein each cluster in the set of clusters includes one or more of the numerical embeddings of the entity names in the plurality of entity names;
generating a candidate cluster merge between a first cluster in the set of clusters and a second cluster in the set of clusters with which the first cluster has the smallest distance value or largest similarity value;
prompting an auditing system to accept or reject the candidate cluster merge;
in response to the auditing system accepting the candidate cluster merge, merging the first cluster and the second cluster; and
determining a standardized entity name for entity names within the first cluster and second cluster.

2. The computer-implemented method of claim 1, further comprising:
determining another candidate cluster merge between a third cluster in the set of clusters and a fourth cluster in the set of clusters with which the third cluster has the smallest distance value or largest similarity value;
prompting the auditing system to accept or reject the another candidate cluster merge;
in response to the auditing system rejecting the another candidate cluster merge, updating the distance or similarity value between the third cluster and the fourth cluster such that after the updating, the third cluster and fourth cluster are dissimilar.

3. The computer-implemented method of claim 1, further comprising:
in response to merging the first cluster and the second cluster, updating the similarity or distance values between each pair of clusters in the set of clusters;
determining another candidate cluster merge between the pair of clusters in the set of clusters that have the smallest distance value or largest similarity value.

4. The computer-implemented method of claim 1, further comprising:
scoring the candidate cluster merge; and
choosing the auditing system based on the scoring, wherein the choosing comprises selecting a first auditing system when the scoring falls within a predefined range and a second auditing system when the scoring falls outside of the predefined range.

5. The computer-implemented method of claim 4, wherein the first auditing system is a user of a client device and the second auditing system is the language processing system.

6. The computer-implemented method of claim 1, further comprising:
generating distance or similarity values between numerical representations of a first entity name in the plurality of entity names and another plurality of entity names in a reference dataset;
determining a candidate match between the first entity name in the plurality of entity names and an entity name in the another plurality of entity names with which the first entity name has the smallest distance or largest similarity value;
prompting the auditing system to accept or reject the candidate match; and
in response to the auditing system accepting the candidate match, altering the first entity name to match the entity name in the another plurality of entity names with which the first entity name has the smallest distance or largest similarity value.

7. The computer-implemented method of claim 1, further comprising:
generating distance or similarity values between numerical representations of a first entity name and another plurality of entity names in a reference dataset;
determining a candidate match between the first entity name in the plurality of entity names and an entity name in the another plurality of entity names with which the first entity name has the smallest distance or largest similarity value;
prompting the auditing system to accept or reject the candidate match; and
in response to the auditing system rejecting the candidate match, repeating the determining and prompting with the remaining entity names in the another plurality of entity names with which the first entity name has not been matched until the candidate match is accepted or a predetermined number of iterations is reached.

8. A system, comprising:
a memory; and
one or more processors coupled to the memory and configured to perform operations comprising:
preprocessing a plurality of entity names in a target dataset by prompting a language processing system to provide edits to the plurality of entity names;
generating numerical embeddings of the entity names in the plurality of entity names using a text embedding model;
generating similarity or distance values between each pair of clusters in a set of clusters, wherein each cluster in the set of clusters includes one or more of the numerical embeddings of the entity names in the plurality of entity names;
generating a candidate cluster merge between a first cluster in the set of clusters and a second cluster in the set of clusters with which the first cluster has the smallest distance value or largest similarity value;
prompting an auditing system to accept or reject the candidate cluster merge;
in response to the auditing system accepting the candidate cluster merge, merging the first cluster and the second cluster; and
determining a standardized entity name for entity names within the first cluster and second cluster.

9. The system of claim 8, the operations further comprising:
determining another candidate cluster merge between a third cluster in the set of clusters and a fourth cluster in the set of clusters with which the third cluster has the smallest distance value or largest similarity value;
prompting the auditing system to accept or reject the another candidate cluster merge;
in response to the auditing system rejecting the another candidate cluster merge, updating the distance or similarity value between the third cluster and the fourth cluster such that after the updating, the third cluster and fourth cluster are dissimilar.

10. The system of claim 8, the operations further comprising:
in response to merging the first cluster and the second cluster, updating the similarity or distance values between each pair of clusters in the set of clusters;
determining another candidate cluster merge between the pair of clusters in the set of clusters that have the smallest distance value or largest similarity value.

11. The system of claim 8, the operations further comprising:
scoring the candidate cluster merge; and
choosing the auditing system based on the scoring, wherein the choosing comprises selecting a first auditing system when the scoring falls within a predefined range and a second auditing system when the scoring falls outside of the predefined range.

12. The system of claim 11, wherein the first auditing system is a user of a client device and the second auditing system is the language processing system.

13. The system of claim 8, the operations further comprising:
generating distance or similarity values between numerical representations of a first entity name in the plurality of entity names and another plurality of entity names in a reference dataset;
determining a candidate match between the first entity name in the plurality of entity names and an entity name in the another plurality of entity names with which the first entity name has the smallest distance or largest similarity value;
prompting the auditing system to accept or reject the candidate match; and
in response to the auditing system accepting the candidate match, altering the first entity name to match the entity name in the another plurality of entity names with which the first entity name has the smallest distance or largest similarity value.

14. The system of claim 8, the operations further comprising:
generating distance or similarity values between numerical representations of a first entity name and another plurality of entity names in a reference dataset;
determining a candidate match between the first entity name in the plurality of entity names and an entity name in the another plurality of entity names with which the first entity name has the smallest distance or largest similarity value;
prompting the auditing system to accept or reject the candidate match; and
in response to the auditing system rejecting the candidate match, repeating the determining and prompting with the remaining entity names in the another plurality of entity names with which the first entity name has not been matched until the candidate match is accepted or a predetermined number of iterations is reached.

15. A non-transitory machine-readable storage medium having instructions stored thereon that, when executed by a set of one or more processors, cause said set of one or more processors to perform operations comprising:
preprocessing a plurality of entity names in a target dataset by prompting a language processing system to provide edits to the plurality of entity names;
generating numerical embeddings of the entity names in the plurality of entity names using a text embedding model;
generating similarity or distance values between each pair of clusters in a set of clusters, wherein each cluster in the set of clusters includes one or more of the numerical embeddings of the entity names in the plurality of entity names;
generating a candidate cluster merge between a first cluster in the set of clusters and a second cluster in the set of clusters with which the first cluster has the smallest distance value or largest similarity value;
prompting an auditing system to accept or reject the candidate cluster merge;
in response to the auditing system accepting the candidate cluster merge, merging the first cluster and the second cluster; and
determining a standardized entity name for entity names within the first cluster and second cluster.

16. The non-transitory machine-readable storage medium of claim 15, the operations further comprising:
determining another candidate cluster merge between a third cluster in the set of clusters and a fourth cluster in the set of clusters with which the third cluster has the smallest distance value or largest similarity value;
prompting the auditing system to accept or reject the another candidate cluster merge;
in response to the auditing system rejecting the another candidate cluster merge, updating the distance or similarity value between the third cluster and the fourth cluster such that after the updating, the third cluster and fourth cluster are dissimilar.

17. The non-transitory machine-readable storage medium of claim 15, the operations further comprising:
in response to merging the first cluster and the second cluster, updating the similarity or distance values between each pair of clusters in the set of clusters;
determining another candidate cluster merge between the pair of clusters in the set of clusters that have the smallest distance value or largest similarity value.

18. The non-transitory machine-readable storage medium of claim 15, the operations further comprising:
scoring the candidate cluster merge; and
choosing the auditing system based on the scoring, wherein the choosing comprises selecting a first auditing system when the scoring falls within a predefined range and a second auditing system when the scoring falls outside of the predefined range.

19. The non-transitory machine-readable storage medium of claim 15, the operations further comprising:
generating distance or similarity values between numerical representations of a first entity name in the plurality of entity names and another plurality of entity names in a reference dataset;
determining a candidate match between the first entity name in the plurality of entity names and an entity name in the another plurality of entity names with which the first entity name has the smallest distance or largest similarity value;
prompting the auditing system to accept or reject the candidate match; and
in response to the auditing system accepting the candidate match, altering the first entity name to match the entity name in the another plurality of entity names with which the first entity name has the smallest distance or largest similarity value.

20. The non-transitory machine-readable storage medium of claim 15, the operations further comprising:
generating distance or similarity values between numerical representations of a first entity name and another plurality of entity names in a reference dataset;
determining a candidate match between the first entity name in the plurality of entity names and an entity name in the another plurality of entity names with which the first entity name has the smallest distance or largest similarity value;
prompting the auditing system to accept or reject the candidate match; and
in response to the auditing system rejecting the candidate match, repeating the determining and prompting with the remaining entity names in the another plurality of entity names with which the first entity name has not been matched until the candidate match is accepted or a predetermined number of iterations is reached.
